(19) United States
(12) Patent Application Publication
(10) Pub. No.: US 2008/0010261 A1
(43) Pub. Date: Jan. 10, 2008

(54) Integrated content file search method for mobile terminal and mobile terminal implementing the same

(75) Inventors: Han Soek Nam, Daegu Metropolitan City (KR); Bong Kyun Kim, Seongnam-si (KR); Hwan Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/812,880

(22) Filed: Jun. 22, 2007

(30) Foreign Application Priority Data
Jul. 6, 2006 (KR) 2006-0063428

(51) Int. Cl. G06F 17/30

(52) U.S. Cl. 707/3

(57) ABSTRACT

An integrated content file search method for a mobile terminal and a mobile terminal implementing the same are provide, in which content files stored in the mobile terminal in a hierarchical or non-hierarchical structure are searched in an integrated manner, and selection of one of the found content files causes immediate execution of the selected content file. A search mode for a content file search is set, a search string from a user is input, the input search string is displayed on a display unit of the mobile terminal, the text entry of content files stored in the mobile terminal are accessed, the text entry is verified to determine whether the text entry contains the input search string, a textual excerpt from the text entry containing the input search string is displayed on the display unit, and a content file that contains the displayed textual excerpt is executed.

### CROSS-REFERENCE TO RELATED PATENT APPLICATION

This application claims the benefit under 35 U.S.C. §119(a) of Korean Patent Application filed in the Korean Intellectual Property Office on Jul. 6, 2006 and assigned Serial No. 2006-0063428, the entire disclosure of which is hereby incorporated by reference.

### BACKGROUND OF THE INVENTION

1. Field of the Invention

The present invention relates generally to an integrated method and mobile terminal for searching a desired content file in the mobile terminal. More particularly, the present invention relates to an integrated content file search method for a mobile terminal wherein content files stored in the mobile terminal in a hierarchical or non-hierarchical structure are searched in an integrated manner, and searched content files can be selected for immediate execution.

2. Description of the Related Art

In recent years, mass-storage devices have been installed in mobile terminals to increase storage capacity. Some mobile terminals include a hard disk drive (HDD) or a high-capacity non-volatile memory device.

With increased storage capacity, various content files (for example, phonebook files, short message files, multimedia message files, electronic mail files, text document files, still picture files, moving picture files, and game program files) are classified according to their categories and stored in a hierarchical structure in a mobile terminal. In a hierarchical structure such as a tree-like structure, a parent-child relation exists between an element (parent) and a next-lower-level element (child). Namely, a parent element can have zero, one or multiple child elements, and a child element can have only one parent element.

Because a large number of content files are stored in a hierarchical structure, it is difficult to know the location of a particular content file in a mobile terminal. Further, in a conventional search approach, content file search is limited to a particular folder or category.

Accordingly, there is a need for an improved method for locating a content file in a mobile terminal and a mobile terminal implementing the same.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an integrated content file search method for a mobile terminal wherein contents files stored in the mobile terminal in a hierarchical or non-hierarchical structure are searched in an integrated manner and selection of one of the found content files causes immediate execution of the selected content file.

In order to achieve the aspects, an exemplary embodiment of the present invention provides an integrated content file search method for a mobile terminal, in which a search mode is set for content file search, a search string from a user is input; the input search string is displayed on a display unit of the mobile terminal, a text entry of content files stored in the mobile terminal is accessed, the text entry is verified to determine whether the text entry contains the input search string, a textual excerpt from the text entry containing the input search string is displayed on the display unit, and a content file that contains the displayed textual excerpt is executed.

In an exemplary implementation, the text entry of content files may include a list of file subjects on the content files. Alternatively, the text entry of content files may include textual contents of the content files.

In another exemplary implementation, a textual excerpt of the corresponding content file is displayed together with an icon indicating the content file.

In still another exemplary implementation, selection of a displayed icon causes execution of the content file associated with the icon.

In a further exemplary implementation, the icon is represented in the form of an avatar.

In order to achieve the aspects, an exemplary embodiment of the present invention provides a mobile terminal which includes: a key input unit for setting a search mode for a content file search and inputting a search string; a display unit for displaying the input search string; a controller for accessing a text entry of content files, verifying the text entry to determine whether the text entry contains the input search string, displaying a textual excerpt from the text entry containing the input search string, and executing a content file that contains the textual excerpt.

### BRIEF DESCRIPTION OF THE DRAWINGS

The above and other objects, features and advantages of certain exemplary embodiments of the present invention will be more apparent from the following detailed description in conjunction with the accompanying drawings, in which:

FIG. 1 illustrates a configuration of a mobile terminal according to an exemplary embodiment of the present invention;

FIG. 2 is a flow chart illustrating steps of an integrated content file search method for a mobile terminal according to an exemplary embodiment of the present invention; and

FIG. 3 illustrates a display screen representation resulting from execution of the search method of FIG. 2.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

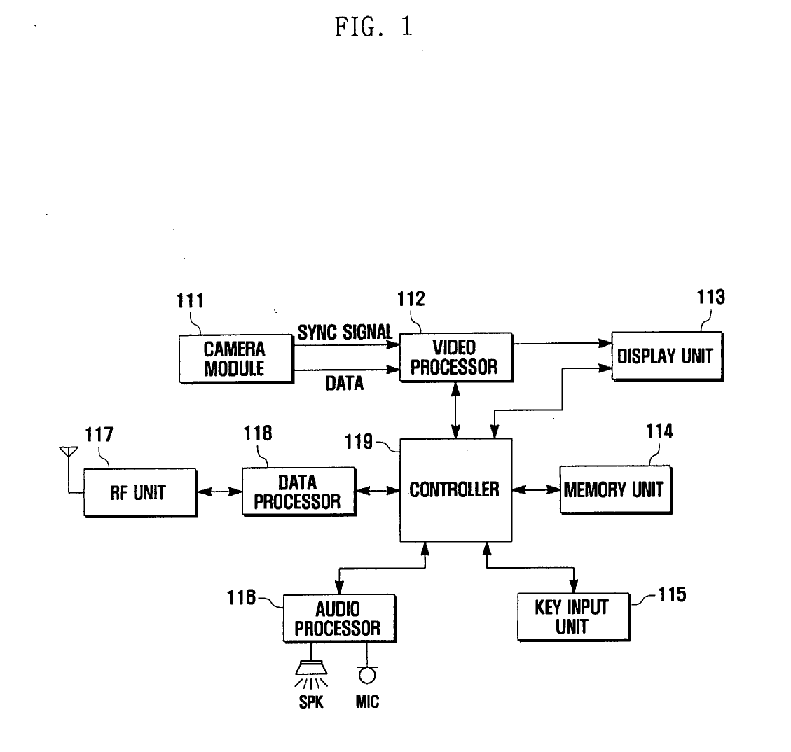

FIG. 1 illustrates a configuration of a mobile terminal according to an exemplary embodiment of the present invention.

Referring to FIG. 1, the mobile terminal includes a camera module 111, a video processor 112, a display unit 113, a memory unit 114, a key input unit 115, an audio processor 116, a radio frequency (RF) unit 117, a data processor 118, and a controller 119.

The camera module 111 includes a camera lens for forming an image of a target object, a camera sensor for converting an optical signal corresponding to the formed image into an electrical signal, and a signal processor for converting the analog electrical signal from the camera sensor into digital data. The camera sensor may be a charge-coupled device (CCD) sensor, and the signal processor may be a digital signal processor (DSP). The camera sensor and signal processor may be implemented as a single body or as separate bodies.

The video processor 112 generates screen data to display an image signal from the camera module 111. The video processor 112 processes the image signal from the camera module 111 on a frame-by-frame basis to output frame image data corresponding to display characteristics and the size of the display unit 113. The video processor 112 includes a video coder/decoder (codec) to compress frame image data to be displayed on the display unit 113 in a predetermined format and to decompress compressed frame image data into frame image data. The video codec may be a Joint Photographic Experts Group (JPEG) codec, Moving Picture Experts Group-4 (MPEG-4) codec or wavelet codec. The video processor 112 may also perform an on screen display (OSD) function, and output OSD data corresponding to the picture size under the control of the controller 119.

The display unit 113 displays an image signal from the video processor 112, and data from the controller 119 on a screen. The display unit 113 may include a panel that is composed of display devices such as liquid crystal display (LCD) devices or organic light emitting diodes (OLED). In an exemplary implementation, the panel has a touch screen capability.

The memory unit 114 includes a program memory section and a data memory section. The program memory section stores executable programs of the mobile terminal, and the data memory section temporarily stores data resulting from execution of the programs. In an exemplary implementation, the memory unit 114 includes a hard disk drive for a mobile terminal or a non-volatile memory device such as a flash memory.

The key input unit 115 includes a plurality of keys for inputting numeric data, text data and phone numbers, and a plurality of function keys for setting functions of the mobile terminal. The key input unit 115 may further include shortcut keys such as keys labeled by ‘#’ and ‘*’.

The audio processor 116 reproduces an audio signal from an audio codec of the data processor 18, and transmits an audio signal from a microphone (MIC) to the audio codec of the data processor 18.

The RF unit 117 performs wireless communication operations for the mobile terminal. The RF unit 117 includes a RF transmitter for upconverting the frequency of a signal to be transmitted and amplifying the signal, and an RF receiver for low-noise amplifying a received signal and downconverting the frequency of the signal.

The data processor 118 includes a transmitter for encoding and modulating a signal to be transmitted, and a receiver for demodulating and decoding a received signal. The data processor 118 may include a modem and a codec. The codec includes a data codec for processing packet data, and an audio codec for processing an audio signal such as a voice signal.

The controller 119 controls the overall operation of the mobile terminal. The controller 119 may include the data processor 118. The controller 119 is connected to the video processor 112, display unit 113, memory unit 114, key input unit 115, audio processor 116 and data processor 18, and controls these components to exchange and process data, and to establish a call.

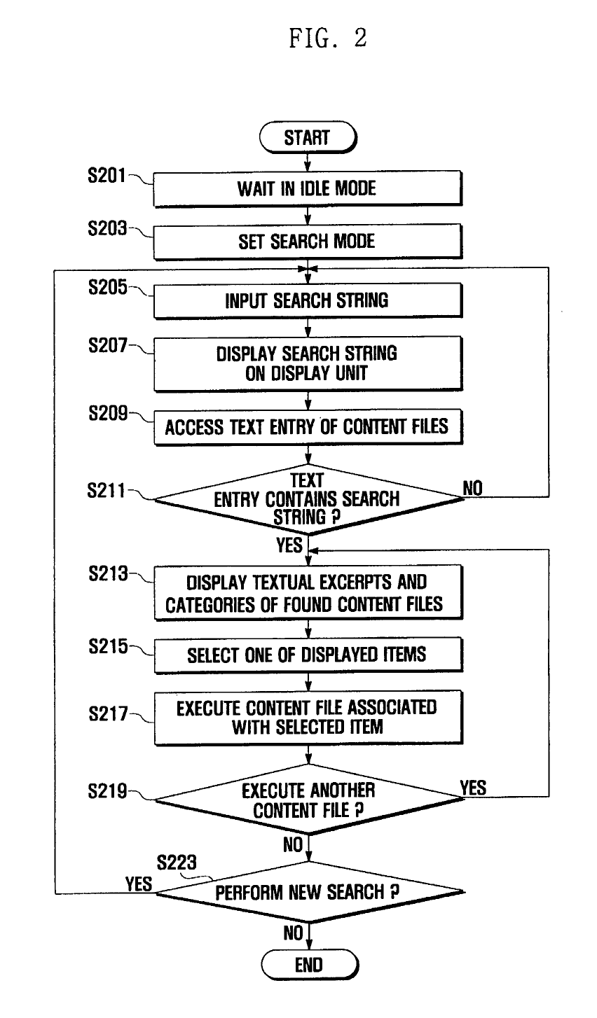

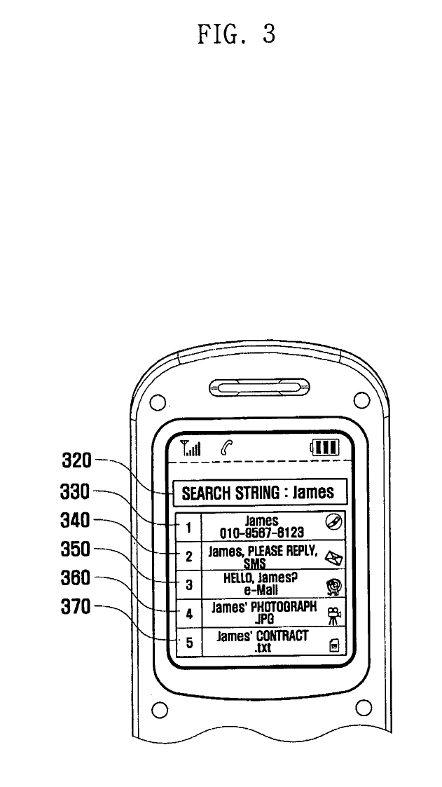

FIG. 2 is a flow chart illustrating steps of an integrated content file search method for a mobile terminal according to an exemplary embodiment of the present invention; and FIG. 3 illustrates a display screen representation resulting from execution of the search method of FIG. 2.

Referring to FIG. 2, the mobile terminal is initially in an idle mode after power-on (S201).

The user inputs a predetermined key to set a search mode for finding a desired content file (S203).

Content files include various data files such as phonebook files, short message files, multimedia message files, electronic mail files, text document files, still picture files, moving picture files, and game program files.

In setting a search mode, a search range may be reduced by limiting categories of content files to be searched. For example, a search range may be set to include phonebook files in the mobile terminal, or set to include short message files, multimedia message files and electronic mail files.

If a search range is set to include file contents in addition to file subjects, a content file containing a particular search string in textual contents thereof can be found.

The user inputs a search string using a keypad of the key input unit 115 or a touch screen of the display unit 113 (S205).

The controller 119 displays the input search string on a screen of the display unit 113 (S207).

The controller 119 accesses a text entry of content files (S209). The text entry of content files stored in the mobile terminal may include a list of file subjects on the content files.

In an exemplary implementation, each content file to be stored in the mobile terminal has at least one file subject. Thereby a content file whose file subject contains an input search string can be found.

The text entry of content files may also include textual contents of the content files. If the search range is set to include file contents in addition to file subjects, a content file containing the input search string in the textual contents can be found. For example, if the contents of a document file contain an input search string, the file name of the document file is output.

The controller 119 checks the text entry to determine whether at least one content file containing the input search string exists (S211).

If no content file containing the input search string is found, the controller 119 returns to step S205 to input a search string for a new search.

If a content file that contains the input search string is found, a textual excerpt and/or a file subject containing the input search string from the text entry, and a category of the found content file is displayed on the display unit 113 (S213).

FIG. 3 illustrates a search result when a search string ‘James’ is input in a search field 320 of the display unit 113. Every content file whose file subject or textual contents contains the search string ‘James’ is found. In FIG. 3, content files, such as a phone book file 330, a text message file 340, an electronic mail file 350, a still picture file 360, and a document file 370 are found, and textual excerpts and/or file subjects of the found content files are displayed in a list of search results.

In addition, an icon indicating a file category is displayed in the list of search results for easy identification of the category of a corresponding content file. The icon can be represented in the form of an avatar.

The user selects a displayed item in a list of search results for execution of a content file associated with the selected item (S215). The user can select a file sequence number or an icon in the list of search results using a key of the key input unit 115 or a touch screen of the display unit 113.

A content file associated with the selected item is entered into an execution mode and executed (S217).

The controller 119 asks the user whether to execute another content file in the list of search results (S219).

If the user decides to execute another content file in the list of search results at step S219, the controller 119 returns to step S213 and repeats step S213 and subsequent steps to execute another content file.

If the user decides not to execute another content file at step S219, the controller 119 asks the user whether to perform a new search (S223).

If the user inputs a command key for setting a search mode, the controller 119 returns to step S205 and repeats step S205 and subsequent steps to perform a new search.

As apparent from the above description, exemplary embodiments of the present invention provide an integrated content file search method for a mobile terminal. Content files stored in the mobile terminal in a hierarchical or non-hierarchical structure are searched in an integrated manner, and selection of one of the found content files causes immediate execution of the selected content file. Thereby a desired content file can be easily found and executed.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An integrated content file search method for a mobile terminal, the method comprising:
setting a search mode for a content file search;
inputting a search string;
displaying the input search string on a display unit;
accessing a text entry of stored content files;
verifying the text entry to determine whether the text entry contains the input search string;
displaying a textual excerpt from the text entry containing the input search string on the display unit; and
executing a content file that contains the displayed textual excerpt.

2. The integrated content file search method of claim 1, wherein the text entry of the stored content files includes a list of file subjects on the content files.

3. The integrated content file search method of claim 1, wherein the text entry of the stored content files includes textual contents of the content files.

4. The integrated content file search method of claim 1, wherein the displaying of the textual excerpt comprising displaying a textual excerpt of the corresponding content file is displayed together with an icon indicating the content file.

5. The integrated content file search method of claim 4, further comprising selecting an icon to execute the content file associated with the icon.

6. The integrated content file search method of claim 4, wherein the icon comprises an avatar.

7. The integrated content file search method of claim 1, wherein the content files comprises at least one of phone book files, short message files, multimedia message files, electronic mail files, text document files, still picture files, moving picture files and game program files.

8. A mobile terminal comprising:
a key input unit for setting a search mode for a content file search and inputting a search string;
a display unit for displaying the input search string;
a controller for accessing a text entry of content files, verifying the text entry to determine whether the text entry contains the input search string, displaying a textual excerpt from the text entry containing the input search string, and executing a content file that contains the textual excerpt.

9. The mobile terminal of claim 8, wherein the text entry of content files comprises a list of file subjects on the content files.

10. The mobile terminal of claim 8, wherein the text entry of content files comprises textual contents of the content files.

11. The mobile terminal of claim 8, wherein the textual excerpt is displayed together with an icon indicating the content file.

12. The mobile terminal of claim 11, wherein selection of the icon executes the content file associated with the icon.

13. The mobile terminal of claim 11, wherein the icon comprises an avatar.

14. The mobile terminal of claim 8, wherein the content files comprises at least one of phone book files, short message files, multimedia message files, electronic mail files, text document files, still picture files, moving picture files and game program files.
